(19) United States
(12) Patent Application Publication
(10) Pub. No.: US 2024/0073269 A1
(43) Pub. Date: Feb. 29, 2024

(54) NON-FUNGIBLE TOKENS AS SOUVENIRS OF MULTIMEDIA COMMUNICATION SESSIONS

(71) Applicant: Cisco Technology, Inc., San Jose, CA (US)

(72) Inventors: Abhay Sudhakar Kulkarni, Saratoga, CA (US); Kai Wang, Vancouver (CA); Li Li, Zhejiang (CN)

(21) Appl. No.: 17/895,539

(22) Filed: Aug. 25, 2022

(51) Int. Cl. H04L 65/613; G06F 3/0482; H04L 65/1089; H04L 65/1096

(52) U.S. Cl. CPC H04L 65/613; G06F 3/0482; H04L 65/1089; H04L 65/1096

(57) ABSTRACT

Techniques are provided herein for generating Non-Fungible Tokens (NFTs) as souvenirs of multimedia communication sessions. In one example embodiment, during a multimedia communication session with a plurality of participants, an indication to generate an NFT from content of the multimedia communication session is obtained from a first participant of the plurality of participants. Content data is captured from the multimedia communication session as the multimedia communication session is occurring. The NFT is generated from the content data. The NFT is a souvenir of the multimedia communication session.

### TECHNICAL FIELD

The present disclosure relates to multimedia communication sessions.

### BACKGROUND

A Non-Fungible Token (NFT) creates a cryptographically unique token of any artifact. The conception of NFTs created a prime opportunity for artists to sell their works online as though the works were physical; as a result, art is currently the most popular form of NFT. NFTs also allow music—which has been recorded and distributed on records, cassettes, Compact Discs (CDs), and digitally as a fungible good for decades—to be sold as a non-fungible good. Furthermore, companies are now selling sell in-game content, like skins, characters, and other items, as NFTs. In addition, virtual fashion NFTs can be used for dressing online avatars. NFTs have also been applied to collectible items (e.g., trading cards), memes, and other use cases.

### BRIEF DESCRIPTION OF THE DRAWINGS

FIG. 1 illustrates a system configured to generate a Non-Fungible Token (NFT) as a souvenir of a multimedia communication session, according to an example embodiment.

FIG. 2 illustrates a network architecture configured for generating an NFT as a souvenir of a multimedia communication session, according to an example embodiment.

FIGS. 3A-3D illustrate respective user interfaces for configuring a display format of an NFT, according to an example embodiment.

FIG. 4 illustrates a distributed ledger configured to store NFT data, according to an example embodiment.

FIGS. 5A and 5B illustrate an encoded version of an NFT and a decoded version of the NFT, respectively, according to an example embodiment.

FIG. 6 illustrates a method for generating an NFT as a souvenir of a multimedia communication session, according to an example embodiment.

FIG. 7 illustrates a hardware block diagram of a computing device configured to perform functions associated with operations discussed herein, according to an example embodiment.

FIG. 8 illustrates a flowchart of a method for performing functions associated with operations discussed herein, according to an example embodiment.

### DESCRIPTION OF EXAMPLE EMBODIMENTS

### Overview

Techniques are provided herein for generating Non-Fungible Tokens (NFTs) as souvenirs of multimedia communication sessions. In one example embodiment, during a multimedia communication session with a plurality of participants, an indication to generate an NFT from content of the multimedia communication session is obtained from a first participant of the plurality of participants. Content data is captured from the multimedia communication session as the multimedia communication session is occurring. The NFT is generated from the content data. The NFT is a souvenir of the multimedia communication session.

### EXAMPLE EMBODIMENTS

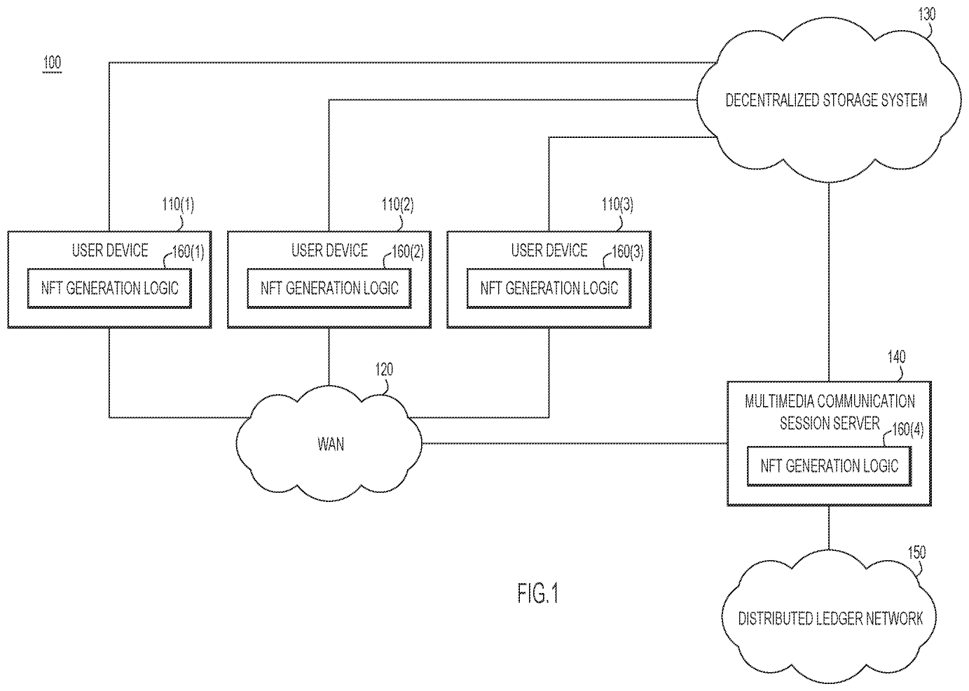

FIG. 1 illustrates a system 100 configured to generate a Non-Fungible Token (NFT) as a souvenir of a multimedia communication session, according to an example embodiment. System 100 includes user devices 110(1)-110(3), Wide Area Network (WAN) 120, decentralized storage system 130, multimedia communication session server 140, and distributed ledger network 150.

User devices 110(1)-110(3) may include laptops, smart phones, tablets, video conference endpoints, etc. WAN 120 may be the Internet. Decentralized storage system 130 may be a trusted, decentralized database/repository service configured to store NFTs, such as the InterPlanetary File System (IPFS). Multimedia communication session server 140 may be configured to host a multimedia communication session. Distributed ledger network 150 may include a publicly distributed database that is shared among a multitude of computer network nodes. Distributed ledger network 150 may be a main blockchain network, such as an Ethereum network that includes one or more Ethereum Virtual Machines (EVMs), and may be accessed by user devices 110(1)-110(3).

User devices 110(1)-110(3) may be operated by geographically dispersed participants to join the multimedia communication session hosted by multimedia communication session server 140 via WAN 120. User devices 110(1)-110(3) may obtain audio and/or video feeds of the respective participants and relay the audio/video feeds to multimedia communication session server 140. Multimedia communication session server 140 may, in turn, distribute the audio/video feeds to user devices 110(1)-110(3). User devices 110(1)-110(3) may output the audio/video feeds to enable the respective participants to engage in the multimedia communication session.

Sometimes, a participant may wish to disable their video feed for at least some of the multimedia communication session. In that case, the participant may select an option to disable the video feed (e.g., turn their camera off). Instead of providing the video feed of the participant to one or more of user devices 110(1)-110(3), multimedia communication session server 140 may provide an avatar for display. The avatar may be any suitable image (e.g., a picture of the participant). The participant may select and/or customize their avatar as desired.

The multimedia communication session may be a video conference, teleconference, webinar (online seminar), training session, etc. The multimedia communication session may be a large event or a small event, such as a one-on-one event (in which case only two of user devices 110(1)-110(3) would join the multimedia communication session). In one example, the multimedia communication session may mark a special occasion (e.g., a birthday, sendoff, retirement, etc.). In one specific example, a celebrity may join the multimedia communication session to make an appearance.

Conventionally, if a participant wanted to generate a souvenir of a multimedia communication session, the participant would take a screenshot of a meeting grid view. However, by their nature, screenshots can capture only information that is displayed at the time the screenshot is taken. As a result, screenshots can result in loss of information such as video, audio, and metadata regarding the multimedia communication session. Furthermore, a screenshot, by itself, lacks security measures to verify the legitimacy of the screenshot (e.g., to prove that the screenshot was not doctored).

Accordingly, to enable the respective participants to generate a verifiable souvenir capable of dynamically capturing a wide range of information regarding the multimedia communication session in real-time, user devices 110(1)-110(3) and multimedia communication session server 140 include NFT generation logic 160(1)-160(4), respectively. NFT generation logic may cause user devices 110(1)-110(3) and multimedia communication session server 140 to perform operations described herein with respect to generating an NFT as a souvenir of the multimedia communication session. In certain embodiments described herein, user device 110(1) performs operations for generating the NFT; however, it will be appreciated that any one or more of user devices 110(1)-110(3) and/or multimedia communication session server 140 may perform the techniques described herein.

In one example, during the multimedia communication session, user device 110(1) obtains, from a first participant, an indication to generate an NFT from content of the multimedia communication session. User device 110(1) captures content data from the multimedia communication session as the multimedia communication session is occurring. In one example, user device 110(1) may capture the content data responsive to the indication to generate the NFT; in another example, user device 110(1) may automatically capture the content data continuously or occasionally (e.g., periodically). The content data may include any suitable data, such as a video segment, an image frame, an avatar, and/or an audio segment of at least one of the participants.

User device 110(1) may generate the NFT from the content data. The NFT is a souvenir of the multimedia communication session. Thus, in one example, user device 110(1) may generate an immutable souvenir/memory/snapshot (i.e., the NFT) of a video meeting/interaction in response to a request from a participant to create the NFT. The NFT may be stored in a cryptocurrency wallet and shared virtually, e.g., on social media.

The NFT may be subjectively valuable to the participant responsible for generating the NFT. For example, the NFT might capture an announcement, made over the multimedia communication session, that the participant is being promoted. Because the NFT may allow the bearer of the NFT (e.g., the participant) to uniquely claim their presence in a special event like a promotion, the participant may choose to keep the NFT as a validated souvenir for their memory. Or, if the NFT is objectively valuable (e.g., if the NFT captures a celebrity who joined the multimedia communication session), it may be traded in various cryptocurrency exchanges. If the participant believes that the NFT may gain objective value in the future, the participant may choose to hold the NFT and sell it later. The NFT may also be used for fundraising, auction, campaign, or promotional events. In certain examples, NFT sales platforms may charge a mint fee to add the NFT to a distributed ledger, a service fee on sales, and/or a royalty fee payable to the original creator of the NFT.

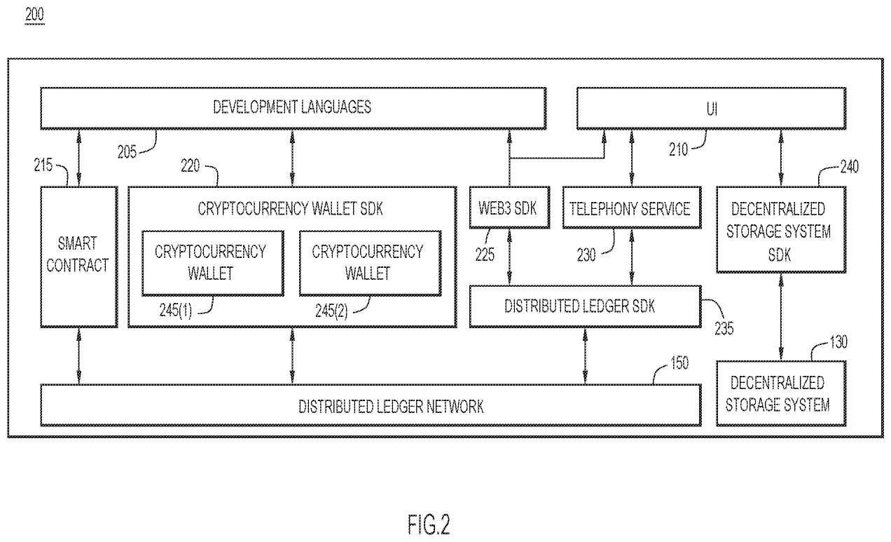

With continuing reference to FIG. 1, FIG. 2 illustrates a network architecture 200 configured for generating an NFT as a souvenir of a multimedia communication session, according to an example embodiment. Network architecture 200 includes development languages 205, User Interface (UI) 210, and smart contract 215. Network architecture 200 further includes cryptocurrency wallet Software Development Kit (SDK) 220, Web3 SDK 225, telephony service 230, distributed ledger SDK 235, and decentralized storage system SDK 240. Network architecture 200 also includes distributed ledger network 150 and decentralized storage system 130.

Development languages 205 may include a markup language (e.g., Hypertext Markup Language (HTML)), a design language (e.g., Cascading Style Sheets (CSS)), a programming language (e.g., JavaScript), etc. UI 210 may be any suitable graphical user interface of a multimedia communication session application that enables a user to participate in a multimedia communication session. For example, UI 210 may enable a user to provide an indication to generate an NFT from content of the multimedia communication session. Smart contract 215 may be a digital contract that is stored in distributed ledger network 150 and automatically executed when predetermined terms and conditions are met. Smart contract 215 may be written using any suitable programming language, such as Solidity. In one example, one or more EVMs in distributed ledger network 150 may execute smart contract 215.

Cryptocurrency wallet SDK 220 includes cryptocurrency wallet 245(1) (e.g., a MetaMask wallet) and cryptocurrency wallet 245(2) (e.g., a Coinbase wallet). Cryptocurrency wallets 245(1) and 245(2) may support the distributed ledger protocol on which the NFTs are built, and may also support the cryptocurrency (e.g., Ethereum) with which NFTs are bought and sold. Cryptocurrency wallets 245(1) and 245(2) may be provided by a host of the multimedia communication session or by a corporate account hosting the multimedia communication session.

Cryptocurrency wallets 245(1) and 245(2) may be integrated with the multimedia communication session. More specifically, a participant acting as a consumer/recipient may pay to generate an NFT using cryptocurrency stored in cryptocurrency wallets 245(1) and/or 245(2), where the NFT may be transferred after it is generated. For example, the participant may pay to mint a tokenId (e.g., a nonce) for the NFT. After the NFT has been generated, the participant may view/access it using cryptocurrency wallets 245(1) and/or 245(2). While only two cryptocurrency wallets are shown in FIG. 2, it will be appreciated that wallet SDK 220 may include any suitable number of wallets.

Web3 SDK 225 may provide a platform for Web3, a conceptualization of the Internet that incorporates decentralization. Web3 SDK 225 may enable the participant to interact with cryptocurrency wallets 245(1) and 245(2) and distributed ledger network 150. To that end, any suitable library may be used to access Web3. In one example, the library may be capable of Hypertext Transfer Protocol (HTTP) communication (e.g., a native HTTP request library such as CPPRest).

Telephony service 230 may be provided by at least multimedia communication session server 140. Telephony service 230 may involve hosting the multimedia communication session and obtaining video/audio feeds and distributing them amongst the participants. Distributed ledger SDK 235 may provide a platform for building and interacting with distributed ledger network 150. Similarly, decentralized storage system SDK 240 may provide a platform for building and interacting with decentralized storage system 130.

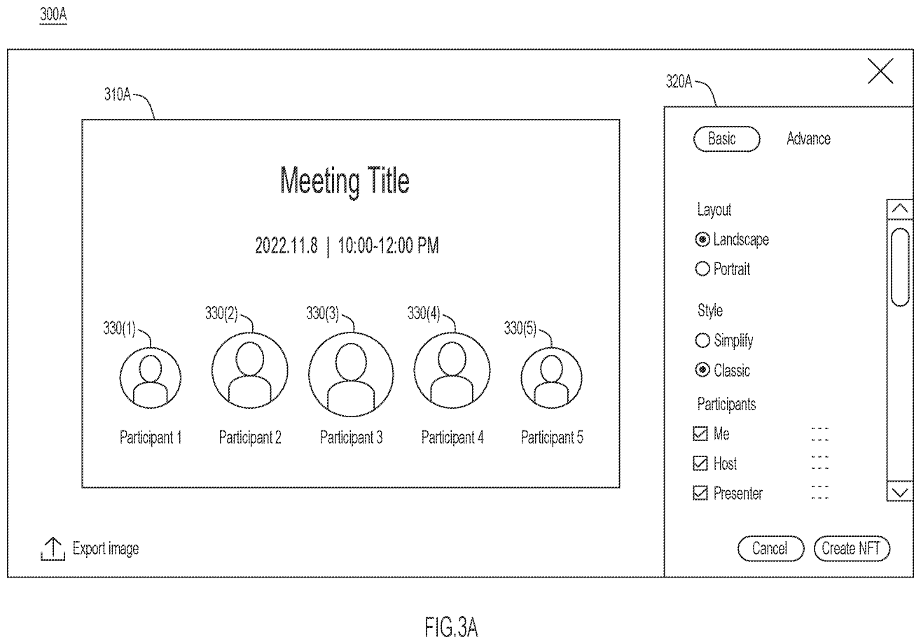

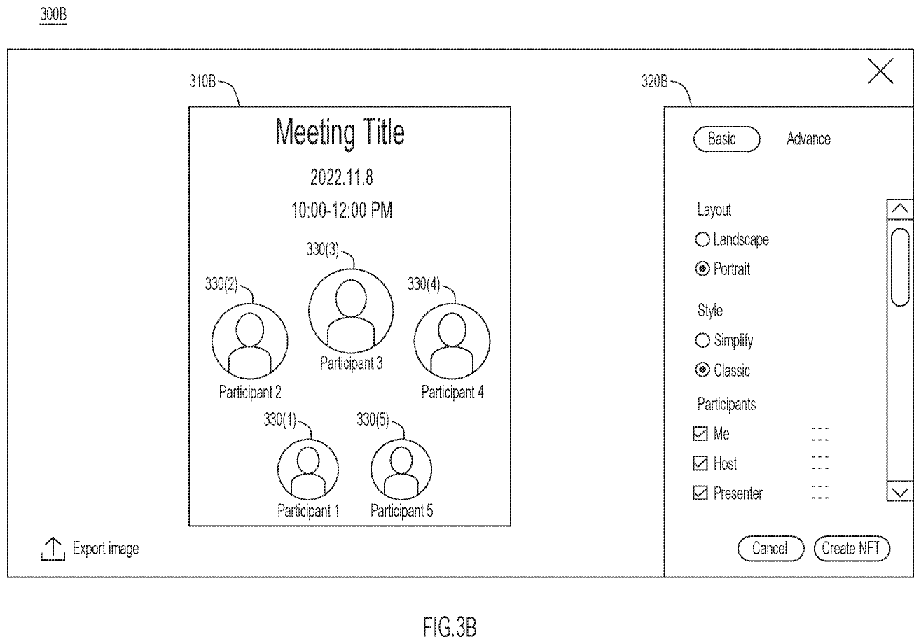

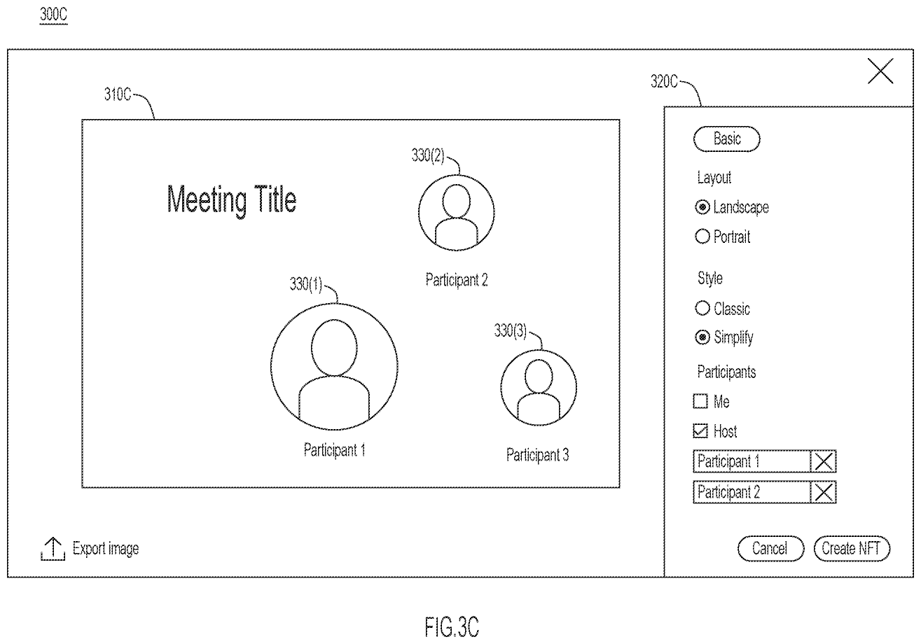

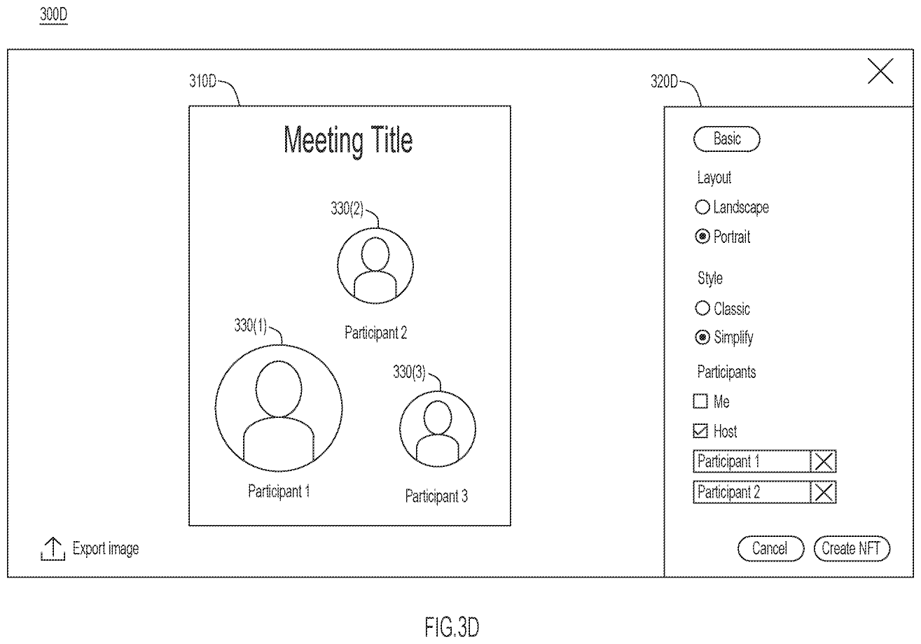

With continuing reference to FIG. 1, FIGS. 3A-3D illustrate respective UIs 300A-300D for configuring a display format of an NFT, according to an example embodiment. UIs 300A-300D include respective sample windows 310A-310D and respective customization windows 320A-320D. Sample windows 310A-310D illustrate templates of the NFT. Customization windows 320A-320D present various options to configure a display format for creation of the NFT. Based on the options selected in customization windows 320A-320D, sample windows 310A-310D may update the template accordingly.

As shown, customization windows 320A-320D include layout options, style options, and participant options. The layout options enable a participant to toggle between landscape and portrait display setting. The style options enable the participant to toggle between “simplify” and “classic” display settings. The participant options enable the participant to select which participants will be featured in the NFT. Sample window 310A (FIG. 3A) illustrates the appearance of an NFT with the landscape layout in the classic style; sample window 310B (FIG. 3B) illustrates the appearance of an NFT with the portrait layout in the classic style; sample window 310C (FIG. 3C) illustrates the appearance of an NFT with the landscape layout in the simplify style; and sample window 310D (FIG. 3D) illustrates the appearance of an NFT with the portrait layout in the simplify style. Customization windows 320A-320D also include a “Create NFT” button which, when selected, causes the NFT to be generated.

UIs 300A-300D may be generated as a side panel or pop-out window by an add-on or embedded application that is integrated with in-meeting context. In operation, user device 110(1) may present a “Moment” button to a first participant in the multimedia communication session. The “Moment” button may be presented for the duration of the multimedia communication session, or for some subset of the multimedia communication session (e.g., when the host enables the “Moment” button). When selected, the “Moment” button may cause user device 110(1) to display UIs 300A-300D.

In one example, user device 110(1) may present, to the first participant, an option to configure a display format for creation of the NFT (e.g., via customization windows 320A-320D). User device 110(2) may obtain, from the first participant, a selected configuration for the display format (e.g., via customization windows 320A-320D). In response to the participant selecting the “Create NFT” button, user device 110(1) may generate the NFT with the selected configuration and store the NFT at an address in decentralized storage system 130.

Sample windows 310A-310D may illustrate a composition of content of the NFT with representations 330(1)-330(3) of participants in the multimedia communication session (sample windows 310A and 310B also illustrate representations 330(4) and 330(5)). Representations 330(1)-330(5) may include embedded video segments, image frames, and/or avatars of the participants, as well as the corresponding names of the participants. The video segments may be recordings of respective video feeds of the participants. The recording may begin when a participant selects the “Create NFT” button and/or selects the participant via customization windows 320A-320D. The video segments may be any suitable length (e.g., ten seconds) and may repeat on a loop. The image frames may be screenshots of the respective video feeds of the participants taken when a participant selects the “Create NFT” button and/or selects the participant via customization windows 320A-320D.

Sample windows 310A-310D may be interactive. In one example, the participant may drag-and-drop representations 330(1)-330(5) to any suitable location within sample windows 310A-310D. For instance, if one of the participants in the multimedia communication session is a celebrity, the participant who is generating the NFT may re-arrange representations 330(1)-330(5) so that the representation of that participant is adjacent to, or nearby, the representation of the celebrity. If the participant is unsatisfied with a video segment or image frame (or with an audio segment corresponding to the video frame), the participant may generate a subsequent video segment or image frame. In one example, a button to generate the subsequent video segment or image frame may be presented when the participant hovers over the video segment or image frame.

In addition to representations 330(1)-330(5), the NFT may also display other attributes (e.g., metadata) of the multimedia communication session. For example, as shown in FIGS. 3A-3D, the meeting title of the multimedia communication session are displayed. The meeting title may indicate the subject/purpose of the multimedia communication session (e.g., a celebration). As shown in FIGS. 3A and 3B the date and time of the multimedia communication session may also be displayed.

The NFT may also/alternatively display an indication of a time during which the NFT was generated (e.g., time of day, day of week, date, any special significance of the day (e.g., a holiday), etc.), and/or an indication of one or more locations of at least one of the participants (e.g., the location of participant generating the NFT and/or the respective locations of other participants). The NFT may also/alternatively display metadata regarding virtual participant reactions (e.g., a thumbs-up reaction to a promotion announcement). The metadata may include the types of reactions, the number of reactions, and which participant generated which reaction. The NFT may also/alternatively display any other suitable attributes (e.g., the roster of participants, a meeting description that includes additional information regarding the multimedia communication session, information that is shared during the multimedia communication session, etc.). In addition, the NFT may include one or more audio segments that correspond to the embedded video segment(s). The participant generating the NFT may be permitted to select or deselect the attributes desired for display in the NFT. It will be appreciated that any suitable template/configuration/customization may be used to generate the NFT.

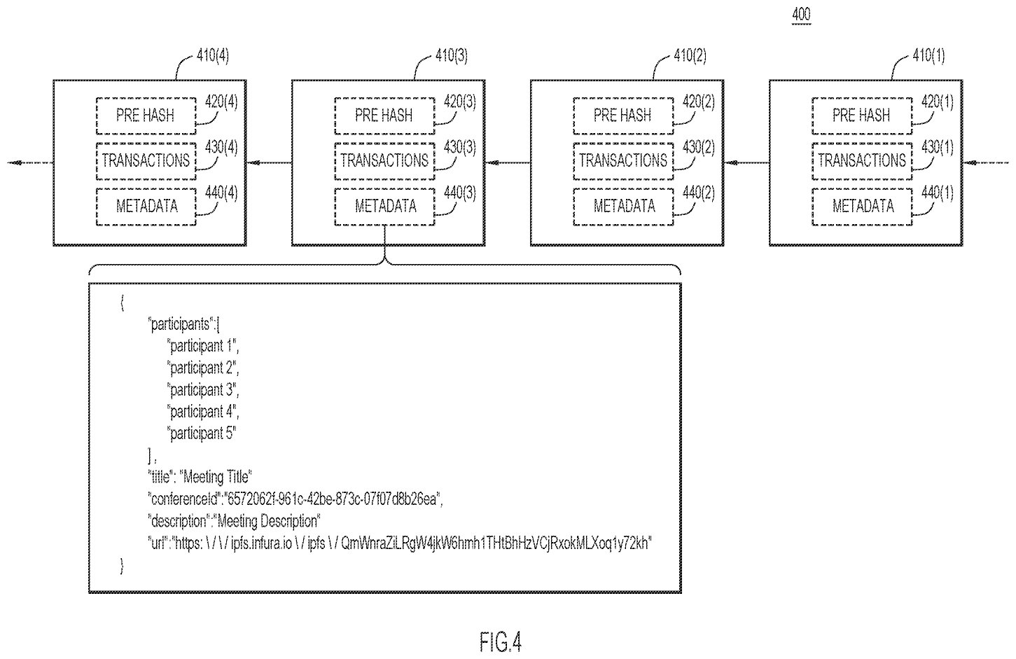

With continuing reference to FIG. 1, FIG. 4 illustrates a distributed ledger 400 configured to store NFT data, according to an example embodiment. In this example, distributed ledger 400 is a blockchain that includes blocks 410(1)-410(4). Each block 410(1)-410(4) includes, respectively, pre-hash 420(1)-420(4), transactions 430(1)-430(4), and metadata 440(1)-440(4). In one example, one or more of blocks 410(1)-410(4) may store metadata of the multimedia communication session after the participant selected the “Create NFT” button (illustrated in FIGS. 3A-3D).

More specifically, after the participant selects the “Create NFT” button, user device 110(1) may store, in block 410(3) of distributed ledger 400 as metadata 440(3), metadata of the multimedia communication session and the address where the NFT is stored in decentralized storage system 130. The metadata of the multimedia communication session may include an indication of: the participants in the multimedia communication session; a title of the multimedia communication session; a communication session identifier (e.g., conference identifier) of the multimedia communication session, and a description of the multimedia communication session. One or more items of metadata of the multimedia communication session may be automatically pulled from the multimedia communication session. In this example, the address where the NFT is stored is a Uniform Resource Locator (URL); as a result, the URL may link to the generated NFT.

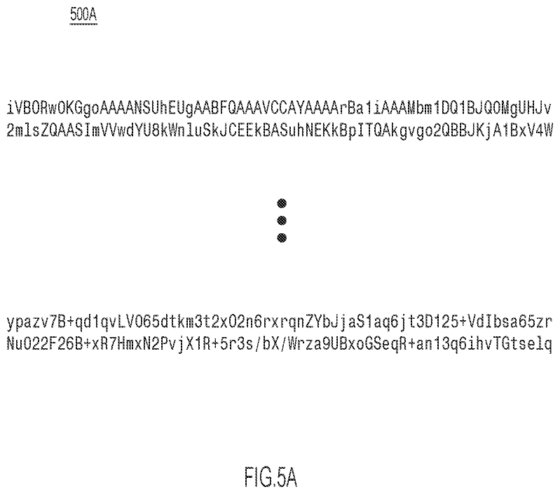

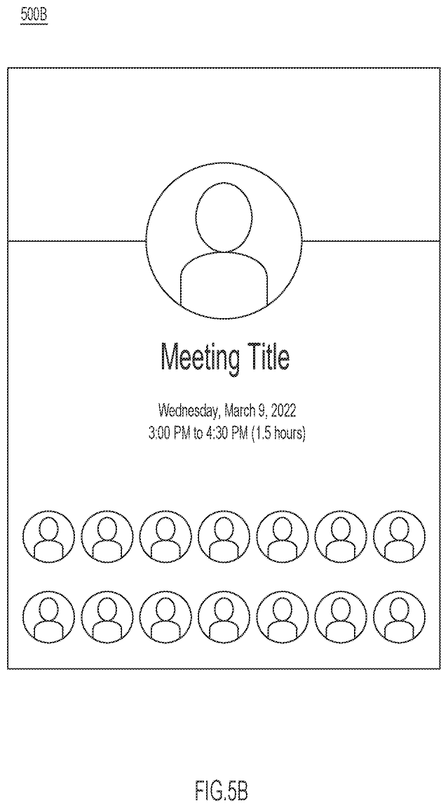

With continuing reference to FIGS. 1 and 4, FIG. 5A illustrates an encoded version 500A of an NFT, and FIG. 5B illustrates a decoded version 500B of the NFT, according to an example embodiment. Encoded version 500A may be a Base64-encoded string that, when decoded, generates decoded version 500B. Decoded version 500B may be formatted as any suitable file type (e.g., PNG, JPG, MP4, etc.). In one example, the participant may access the URL stored in distributed ledger 400 and navigate to the corresponding location in decentralized storage system 130, where encoded version 500A is stored as the NFT. The participant may decode encoded version 500A (e.g., using an Internet service) to view decoded version 500B, which may be signed by the participant generating the NFT. Decoded version 500B may include file extensions in which attributes regarding the multimedia communication session may be stored.

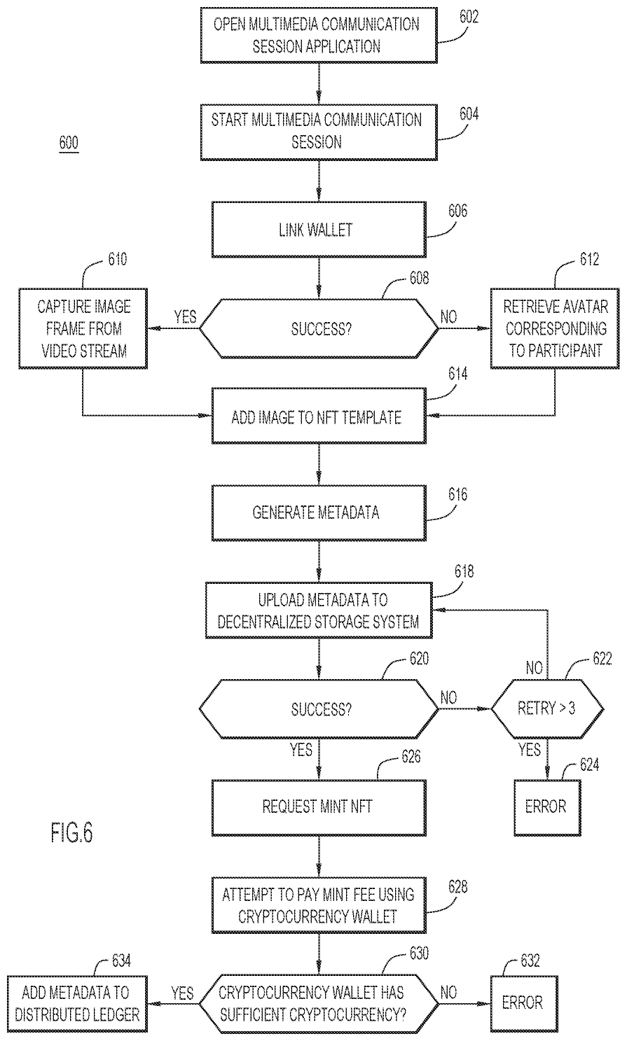

With continuing reference to FIG. 1, FIG. 6 illustrates a method 600 for generating an NFT as a souvenir of a multimedia communication session, according to an example embodiment. At operation 602, a participant may open a multimedia communication session application on user device 110(1). Opening the multimedia communication session application may automatically prompt a smart contract to deploy.

At operation 604, the participant starts a multimedia communication session using the multimedia communication session application. At operation 606, the participant links a cryptocurrency wallet to the multimedia communication session. In one example, user device 110(1) may present a QR code that enables the participant to link/connect the cryptocurrency wallet of choice to the multimedia communication session via their smartphone.

The host may enable an option to generate an NFT at the time of scheduling or on-the-fly during the multimedia communication session. In any event, at some point during the multimedia communication session, the participant provides an indication to generate the NFT. At operation 608, user device 110(1) determines whether a video stream of a participant is available. If the video stream is available, then at operation 610, user device 110(1) captures an image frame from the video stream. User device 110(1) may obtain the image frame using wireless multimedia extensions. If the video stream is not available, then at operation 612, user device 110(1) retrieves an avatar (e.g., avatar image) corresponding to the participant. User device 110(1) may obtain the avatar using an avatar manager. At operation 614, user device 110(1) adds the participant image to an NFT template (e.g., poster image layout, video layout). User device 110(1) may repeat operations 608-614 for any suitable number of participants until the NFT template has been populated with all the desired images.

At operation 616, user device 110(1) generates metadata of the multimedia communication session. At operation 618, user device 110(1) uploads the metadata to decentralized storage system 130. At operation 620, user device 110(1) determines whether the metadata has been uploaded to decentralized storage system 130 successfully. If the upload was not successful, then at operation 622, user device 110(1) determines whether the number of upload attempts exceeds three. If the number of upload attempts does not exceed three, then user device 110(1) returns to operation 618. If the number of upload attempts exceeds three, then at operation 624, user device 110(1) reports an error.

With reference back to operation 620, if the upload was successful, then at operation 626, user device 110(1) submits a request to mint the NFT. At operation 628, user device 110(1) attempts to pay a mint fee using the cryptocurrency wallet. At operation 630, user device 110(1) determines whether the cryptocurrency wallet has sufficient cryptocurrency to make the payment. If the cryptocurrency wallet has insufficient cryptocurrency, then at operation 632, user device 110(1) reports an error. If the cryptocurrency wallet has sufficient cryptocurrency, then at operation 634, the metadata uploaded to decentralized storage system 130 is added to a distributed ledger (e.g., in distributed ledger network 150). At this point, the NFT asset has been generated and method 600 is complete.

The participant (e.g., host) responsible for generating the NFT may be prompted to use their cryptographic key-pair to sign the NFT, after which the NFT may be posted to a cryptocurrency wallet of choice. The NFT may be centrally signed by the participant by collecting data from the participant, or locally signed after distributing the NFT to one or more participants (e.g., via the multimedia communication session application). If the wallet is provided by the participant centrally, the NFT may be securely distributed to engaged participants to sign their own composition(s) of the artifact (e.g., image).

After the NFT has been generated, it may be viewed locally by the participants. For example, a link to the NFT may be distributed to the participants via email or other communication mechanism (e.g., an electronic messaging application). The link may be accompanied by associated certification/authenticity information for the participants' records. In one example, before the host enables and publishes the artifact for the participants, each participant may be requested to consent to sharing the participant's video and/or other information to engage in the NFT. If the participant declines, then their information may not be included in the NFT.

The host, when acting as the wallet provider, may control the number of copies of an artifact that can be stored as an NFT. User device 110(1) may generate an auditing record of NFTs that notes when each NFT was generated, who generated each NFT, and the number of NFTs generated during the multimedia communication session.

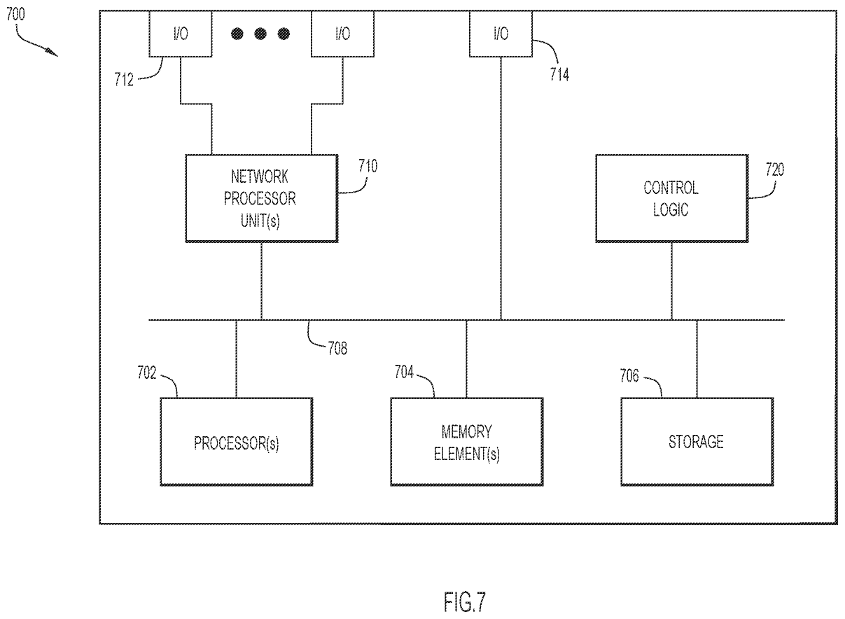

Referring to FIG. 7, FIG. 7 illustrates a hardware block diagram of a computing device 700 that may perform functions associated with operations discussed herein in connection with the techniques depicted in FIGS. 1, 2, 3A-3D, 4, 5A, 5B, and 6. In various embodiments, a computing device, such as computing device 700 or any combination of computing devices 700, may be configured as any entity/entities as discussed for the techniques depicted in connection with FIGS. 1, 2, 3A-3D, 4, 5A, 5B, and 6 in order to perform operations of the various techniques discussed herein.

In at least one embodiment, computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory elements 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, and/or any other I/O port(s) now known or hereafter developed. Thus, the network processor unit(s) 710 and/or network I/O interfaces 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device 700; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), Application Specific Integrated Circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory elements 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to computing device 700 for transfer onto another computer readable storage medium.

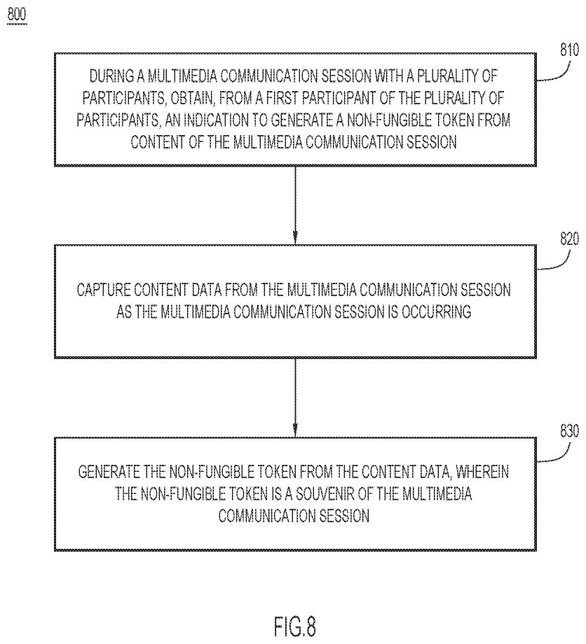

FIG. 8 is a flowchart of an example method 800 for performing functions associated with operations discussed herein. Method 800 may be performed by any suitable entity, such as user devices 110(1)-110(3) and/or multimedia communication session server 140. At operation 810, during a multimedia communication session with a plurality of participants, an indication to generate an NFT from content of the multimedia communication session is obtained from a first participant of the plurality of participants. At operation 820, content data is captured from the multimedia communication session as the multimedia communication session is occurring. At operation 830, the NFT is generated from the content data. The NFT is a souvenir of the multimedia communication session.

As described herein, participants may, at their own disposal, generate an NFT to create a unique, immutable souvenir of memorable moments of a multimedia communication session. The participant may efficiently generate the NFT during the multimedia communication session using a single button on a UI. The NFT may include video, background, text, and/or other participant-selectable content generated from various sources. These techniques may apply cross-platform and may be application-agnostic.

It will be appreciated that, in accordance with techniques described herein, an NFT need not necessarily be generated in real-time. For example, the user may request generation of an NFT after the multimedia communication session has concluded. If the multimedia communication session was recorded, a user (e.g., a participant of the multimedia communication session) may access the recording and retrospectively request generation of an NFT for the multimedia communication session. In one specific example, the NFT may include content data (e.g., video, image frame, audio, avatar, etc.) captured at or near the time in the recording for which the user requests the NFT to be generated.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, entities for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In one form, a method is provided. The method comprises: during a multimedia communication session with a plurality of participants, obtaining, from a first participant of the plurality of participants, an indication to generate a non-fungible token from content of the multimedia communication session; capturing content data from the multimedia communication session as the multimedia communication session is occurring; and generating the non-fungible token from the content data, wherein the non-fungible token is a souvenir of the multimedia communication session.

In one example, capturing the content data includes: capturing a video segment of at least one of the plurality of participants. In another example, capturing the content data includes: capturing an image frame of at least one of the plurality of participants. In still another example, capturing the content data includes: capturing an avatar of at least one of the plurality of participants. In yet another example, capturing the content data includes: capturing an audio segment of at least one of the plurality of participants.

In one example, the method further comprises: storing the non-fungible token at an address in a decentralized storage system; and storing, in a distributed ledger, the address and metadata of the multimedia communication session. In a further example, storing the metadata of the multimedia communication session in the distributed ledger includes: storing, in the distributed ledger, an indication of the plurality of participants, an indication of a title of the multimedia communication session, an indication of a communication session identifier of the multimedia communication session, and an indication of a description of the multimedia communication session.

In one example, the non-fungible token further displays an indication of a time during which the non-fungible token was generated. In another example, the non-fungible token further displays an indication of one or more locations of at least one of the plurality of participants.

In one example, the method further comprises: presenting, to the first participant, an option to configure a display format for creation of the non-fungible token; obtaining, from the first participant, a selected configuration for the display format; and generating the non-fungible token with the selected configuration for the display format.

In another form, an apparatus is provided. The apparatus comprises: a network interface configured to obtain or provide network communications; and one or more processors coupled to the network interface, wherein the one or more processors are configured to: during a multimedia communication session with a plurality of participants, obtain, from a first participant of the plurality of participants, an indication to generate a non-fungible token from content of the multimedia communication session; capture content data from the multimedia communication session as the multimedia communication session is occurring; and generate the non-fungible token from the content data, wherein the non-fungible token is a souvenir of the multimedia communication session.

In another form, one or more non-transitory computer readable storage media are provided. The non-transitory computer readable storage media are encoded with instructions that, when executed by a processor, cause the processor to: during a multimedia communication session with a plurality of participants, obtain, from a first participant of the plurality of participants, an indication to generate a non-fungible token from content of the multimedia communication session; capture content data from the multimedia communication session as the multimedia communication session is occurring; and generate the non-fungible token from the content data, wherein the non-fungible token is a souvenir of the multimedia communication session.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A method comprising:
during a multimedia communication session with a plurality of participants, presenting, to a first participant of the plurality of participants, a user interface for configuring a display format for creation of a non-fungible token from content of the multimedia communication session, the user interface including a first window with a plurality of options for configuring the display format for creation of the non-fungible token and a second window for displaying a sample of the non-fungible token that is customized based on selection of one or more of the plurality of options;
obtaining, from the first participant, an indication to generate the non-fungible token and a selected configuration for the display format;
capturing content data from the multimedia communication session as the multimedia communication session is occurring; and
generating the non-fungible token from the content data with the selected configuration for the display format, wherein the non-fungible token is a souvenir of the multimedia communication session.

2. The method of claim 1, wherein capturing the content data includes:
capturing a video segment of at least one of the plurality of participants.

3. The method of claim 1, wherein capturing the content data includes:
capturing an image frame of at least one of the plurality of participants.

4. The method of claim 1, wherein capturing the content data includes:
capturing an avatar of at least one of the plurality of participants.

5. The method of claim 1, wherein capturing the content data includes:
capturing an audio segment of at least one of the plurality of participants.

6. The method of claim 1, further comprising:
storing the non-fungible token at an address in a decentralized storage system; and
storing, in a distributed ledger, the address and metadata of the multimedia communication session.

7. The method of claim 6, wherein storing the metadata of the multimedia communication session in the distributed ledger includes:
storing, in the distributed ledger, an indication of the plurality of participants, an indication of a title of the multimedia communication session, an indication of a communication session identifier of the multimedia communication session, and an indication of a description of the multimedia communication session.

8. The method of claim 1, wherein the non-fungible token further displays an indication of a time during which the non-fungible token was generated.

9. The method of claim 1, wherein the non-fungible token further displays an indication of one or more locations of at least one of the plurality of participants.

10. (canceled)

11. An apparatus comprising:
a network interface configured to obtain or provide network communications; and
one or more processors coupled to the network interface, wherein the one or more processors are configured to:
during a multimedia communication session with a plurality of participants, presenting, to a first participant of the plurality of participants, a user interface for configuring a display format for creation of a non-fungible token from content of the multimedia communication session, the user interface including a first window with a plurality of options for configuring the display format for creation of the non-fungible token and a second window for displaying a sample of the non-fungible token that is customized based on selection of one or more of the plurality of options;
obtain, from a first participant of the plurality of participants, an indication to generate the non-fungible token and a selected configuration for the display format;
capture content data from the multimedia communication session as the multimedia communication session is occurring; and
generate the non-fungible token from the content data with the selected configuration for the display format, wherein the non-fungible token is a souvenir of the multimedia communication session.

12. The apparatus of claim 11, wherein the one or more processors are configured to:
capture a video segment, an image frame, an avatar, and/or an audio segment of at least one of the plurality of participants.

13. The apparatus of claim 11, wherein the one or more processors are further configured to:
store the non-fungible token at an address in a decentralized storage system; and
store, in a distributed ledger, the address, an indication of the plurality of participants, an indication of a title of the multimedia communication session, an indication of a communication session identifier of the multimedia communication session, and an indication of a description of the multimedia communication session.

14. The apparatus of claim 11, wherein the non-fungible token further displays an indication of a time during which the non-fungible token was generated and/or an indication of one or more locations of at least one of the plurality of participants.

15. (canceled)

16. One or more non-transitory computer readable storage media encoded with instructions that, when executed by a processor, cause the processor to:
during a multimedia communication session with a plurality of participants, present, to a first participant of the plurality of participants, a user interface for configuring a display format for creation of a non-fungible token from content of the multimedia communication session, the user interface including a first window with a plurality of options for configuring the display format for creation of the non-fungible token and a second window for displaying a sample of the non-fungible token that is customized based on selection of one or more of the plurality of options;
obtain, from a first participant of the plurality of participants, an indication to generate the non-fungible token and a selected configuration for the display format;
capture content data from the multimedia communication session as the multimedia communication session is occurring; and
generate the non-fungible token from the content data with the selected configuration for the display format, wherein the non-fungible token is a souvenir of the multimedia communication session.

17. The one or more non-transitory computer readable storage media of claim 16, wherein the instructions cause the processor to:
capture a video segment, an image frame, an avatar, and/or an audio segment of at least one of the plurality of participants.

18. The one or more non-transitory computer readable storage media of claim 16, wherein the instructions further cause the processor to:
store the non-fungible token at an address in a decentralized storage system; and
store, in a distributed ledger, the address, an indication of the plurality of participants, an indication of a title of the multimedia communication session, an indication of a communication session identifier of the multimedia communication session, and an indication of a description of the multimedia communication session.

19. The one or more non-transitory computer readable storage media of claim 16, wherein the non-fungible token further displays an indication of a time during which the non-fungible token was generated and/or an indication of one or more locations of at least one of the plurality of participants.

20. (canceled)

21. The method of claim 1, wherein the plurality of options for configuring the display format include layout options, style options, or participant options.

22. The apparatus of claim 11, wherein the plurality of options for configuring the display format include layout options, style options, or participant options.

23. The one or more non-transitory computer readable storage media of claim 16, wherein the plurality of options for configuring the display format include layout options, style options, or participant options.
